(19) United States
(12) Patent Application Publication
(10) Pub. No.: US 2010/0308146 A1
(43) Pub. Date: Dec. 9, 2010

(54) Structure Of The Knife Set Of The Shredder

(76) Inventor: Tie-Jiun Wang, Taipei (TW)

Correspondence Address: FRENKEL & ASSOCIATES, 3975 UNIVERSITY DR., STE. 330, FAIRFAX, VA, 22030, US

(21) Appl. No.: 12/479,895

(22) Filed: Jun. 8, 2009

(51) Int. Cl. B02C 7/12

(52) U.S. Cl. 241/296

(57) ABSTRACT

The present invention concerns an improvement of the structure of the knife set of the shredder, including one frame, at least two knife-rods corresponding to each other and mobile set on said frame; in addition, each knife-rod has one hollow part respectively and multiple cutters pierce-through set on the outer edge of each knife-rod respectively. Rely on said structure to achieve the effect of making a knife set which is easy to be made, lower manufacturing cost, lighter in weight and less energy demand in operation.

### FIELD OF THE INVENTION

This invention relates to an improved structure of the knife set of the shredder; especially for the structure to achieve the effect of making a knife set which is easy to be made, lower manufacturing cost, lighter in weight and less energy demand in operation.

### DESCRIPTION OF THE PRIOR ART

The knife set of a conventional shredder includes one support rack, at least two mobile knife-rods set on the support rack and multiple cutters set on the knife-rod; at which said knife-rod is normally a metal rod. When manufacturing the knife-rod, said metal rod is cut into a solid column by related mechanical tools to support multiple cutters. By means of said metal rod, said knife set structure can be set on one end of the shredder to proceed the process of shredding papers.

Although aforementioned conventional knife set can cooperate with the shredder to proceed paper-shredding process, said knife-rod which is a solid column made by cutting a metal rod is not easy to be manufactured and the cost will be higher and heavier in weight because of metal material. Moreover, in operation, the weight of metal rod will increase the power demand of the shredder and the shredder may not run smoothly or even be damaged because of long term heavy press caused by knife-rod. Hence, cutters of conventional shredders cannot meet the requirement of practical manufacture and operation.

### SUMMARY OF THE INVENTION

The objective of this invention is to provide a structure of the knife set of the shredder to achieve the effect of making a knife set which is easy to be made, lower manufacturing cost, lighter in weight and less energy needed in operation. For achieving said objective, the invention is an improvement of the structure of the knife set of the shredder, including one frame, at least two corresponding and mobile knife-rod set on said frame; in addition, each knife-rod has one hollow part respectively and multiple cutters pierce-through set on the outer edge of each knife-rod respectively.

### BRIEF DESCRIPTION OF THE DRAWINGS

FIG. 1: a 3-D exterior schematic view of the invention

FIG. 2: a A-A cross-section view of FIG. 1 of the invention

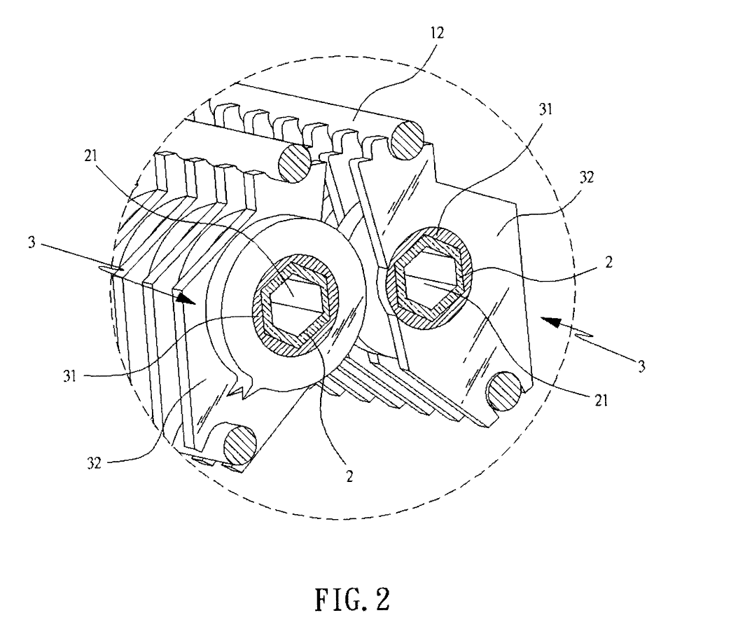

### DETAILED DESCRIPTION OF THE PREFERRED EMBODIMENTS

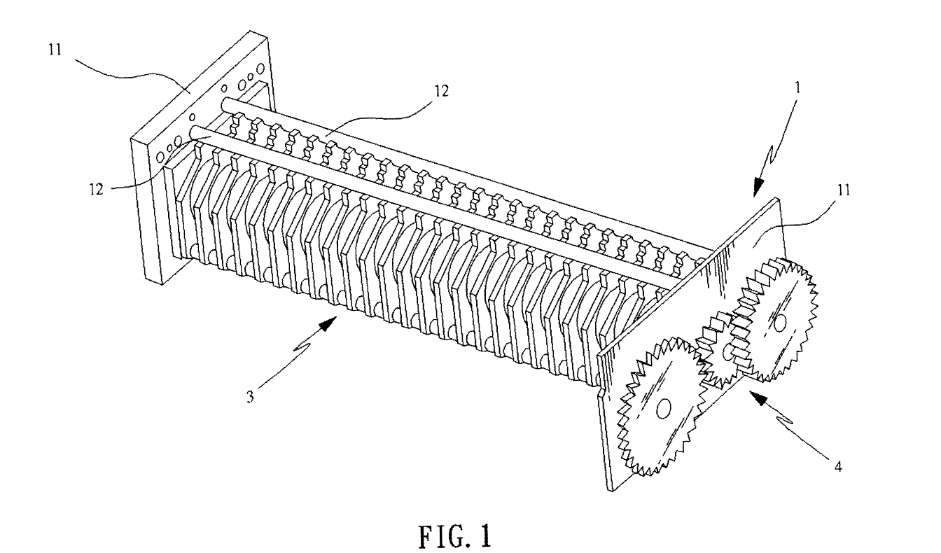

Firstly, referring to fig land 2, they are a 3-D exterior schematic view of the invention and a A-A cross-section view of FIG. 1 of the invention respectively. As the figures show that the invention is a structure improvement of the knife set of a shredder, and said structure is composed of a frame 1, at least two knife-rod 2 and multiple cutters 3.

Said frame 1 is at least composed of two side plates 11 and multiple support rod 12 set between said two side plates 11.

Each knife-rod 2 is respectively corresponding to each other and mobile set on said frame 1, and each knife-rod has a hollow part 21 respectively; at which, outer edge of each knife-rod 2 can be round shape, polygon or ratchet shape. The invention takes polygon as the preferred embodiment.

Each cutter 3 is pierce through set on outer edge of said each knife-rod and each cutter 3 at least includes knife-ring 31 for piercing through set on knife-rod 2 and blade 32 surrounding set the outer edge of knife-ring 31. Hence, by means of said structure, a brandy new improved knife set structure of a shredder has been completed.

When the invention is in operation, there is a driving unit 4 connecting with each knife-rod 2 set on one side of frame 1, and set said knife set structure on one end of the shredder. Connect said driving unit 4 with start motor (not on the figure), and in operation, start motor will drive driving unit 4 to propel each knife-rod 2 for rotating each cutter 3 at the same time to proceed the shredding process by blade 32. Since each knife-rod 2 of the invention has a hollow part 21 respectively, it is easy to achieve the effect of easy to make and lower cost for manufacturing. In addition, the completed product will be lighter in weight, hence, driving force will be saved and save the running energy.

Summing up above description, the improved structure of the knife set of the shredder of the invention can make the knife set of said shredder to achieve the effect of easier to be made, lower manufacturing cost, lighter in weight and less energy demand in operation.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. An improved structure of the knife set of the shredder, at which includes one frame, at least two knife-rod corresponding to each other and mobile set on said frame; each knife-rod has one hollow part respectively and multiple cutters pierce-through set on the outer edge of each knife-rod respectively.

2. An improved structure of the knife set of the shredder as claimed in claim 1, wherein said frame is at least composed of two side plates and multiple support rod set between said two side plates.

3. An improved structure of the knife set of the shredder as claimed in claim 1, wherein a driving unit connecting with each knife-rod set on one side of said frame.

4. An improved structure of the knife set of the shredder as claimed in claim 1, wherein outer edge of each knife-rod is round shape.

5. An improved structure of the knife set of the shredder as claimed in claim 1, wherein outer edge of each knife-rod is polygon.

6. An improved structure of the knife set of the shredder as claimed in claim 1, wherein outer edge of each knife-rod is ratchet shape.

7. An improved structure of the knife set of the shredder as claimed in claim 1, wherein each knife set at least includes one knife-ring for piercing through set on each knife-rod and blades surrounding set on outer edge of the knife-ring.
